(19) United States
(12) Patent Application Publication
(10) Pub. No.: US 2024/0314369 A1
(43) Pub. Date: Sep. 19, 2024

(54) Systems and Methods of Streaming Live Video

(71) Applicant: Live Shop Ventures, LLC, New York, NY (US)

(72) Inventors: Christine Nicole Hershberg, Philadelphia, PA (US); Brian Michael Beitler, Boston, MA (US); Marah Rose Formanek, New York, NY (US); Gerry Hough, New York, NY (US); Justin Shamoun, Chicago, IL (US); Jeeyoo Song, Jersey City, NJ (US)

(21) Appl. No.: 18/606,406

(22) Filed: Mar. 15, 2024

Related U.S. Application Data
(60) Provisional application No. 63/490,422, filed on Mar. 15, 2023.

(51) Int. Cl. H04N 21/2187; H04N 21/431

(52) U.S. Cl. CPC H04N 21/2187; H04N 21/4316

(57) ABSTRACT

In one embodiment, a method includes accessing multiple video streams received at a first computer system by an application executing on the first computer system, the video streams being captured by multiple cameras geographically located at different locations, displaying the video streams as respective thumbnail videos in a graphical user interface (GUI) of the application, receiving a first user selection of at least one video stream via the GUI, receiving a second user selection of a layout from multiple layouts via the GUI, selecting the at least one video stream for broadcasting by the application based on the first user selection, integrating the selected video stream into the selected layout, and transmitting the selected video stream integrated into the selected layout to a first server by the application, which triggers broadcasting of the selected video stream integrated into the selected layout to a second computer system by the first server.

### PRIORITY

This application claims the benefit, under 35 U.S.C. § 119(e), of U.S. Provisional Patent Application No. 63/490,422, filed 15 Mar. 2023, which is incorporated herein by reference.

### TECHNICAL FIELD

This disclosure generally relates to live video streaming.

### BACKGROUND

Livestreaming, live-streaming, or live streaming is the streaming of video or audio in real time or near real time. While often referred to simply as streaming, the real time nature of livestreaming differentiates it from other forms of streamed media, such as video-on-demand, vlogs, etc. Livestreaming services encompass a wide variety of topics, including social media, video games, professional sports, and life casting. Platforms include the streaming of scheduled promotions and celebrity events as well as streaming between users, as in videotelephony.

Livestream shopping (also known as live video shopping) is used by brands to promote and sell products through livestreams on digital platforms, often in collaboration with influencers. The aim is to provide consumers with an immersive and interactive experience, allowing them to, inter alia, ask questions and buy products during the livestream.

### SUMMARY OF PARTICULAR EMBODIMENTS

Particular embodiments may provide a service or a platform that facilitates simulcasting live content between a seller and one or more presenters from one or more locations. Particular embodiments may allow sellers and/or presenters to create a compelling video experience for consumers to observe and transact. In particular embodiments, the service or platform may utilize a plurality of applications to present products for sale in real time. As an example and not by way of limitation, a seller may utilize a seller application running on a computer system (e.g., a laptop, smartphone, desktop computer, etc.) to livestream one or more presenters while the presenters use a presenter application demonstrating and offering products for sale. The live stream may be viewed in real time (or near real time) by consumers using a consumer application (e.g., a mobile application running on a mobile device). The seller application may allow the seller to select from multiple camera views to include in the live stream. As an example and not by way of limitation, the seller application may present two or more camera views (e.g., one showing a presenter interacting with a product and another showing a zoomed-in perspective view of the product), and the seller may be able to select one or multiple (e.g., a split screen) camera views to present to the consumers in the live stream. In addition, the seller application may present real-time updates of product inventory and pricing, thereby allowing the presenters to adjust the focus of product presentations in real time. Although this disclosure describes selecting particular camera views by particular applications in a particular manner, this disclosure contemplates selecting any suitable camera views by any suitable application in any suitable manner.

According to an embodiment, a method includes accessing a plurality of video streams received at a first computer system by an application executing on the first computer system. The plurality of video streams may be captured by a plurality of cameras, respectively. The plurality of cameras may be geographically located at a plurality of different locations. The method also includes displaying, by the application, the plurality of video streams as a plurality of respective thumbnail videos in a graphical user interface (GUI) of the application. The method also includes receiving, via the GUI, a first user selection of at least one video stream of the plurality of video streams. The method additionally includes receiving, via the GUI, a second user selection of a layout from a plurality of layouts. The method then includes selecting, by the application based on the first user selection, the at least one selected video stream for broadcasting. The method then includes integrating, by the application, the at least selected video stream into the selected layout. The method further includes transmitting, by the application, the at least one selected video stream integrated into the selected layout to a first server. The transmission of the at least one selected video stream integrated into the selected layout to the first server may trigger broadcasting of the at least one selected video stream integrated into the selected layout to a second computer system by the first server.

In particular embodiments, the method includes displaying, by the application, a preview of the broadcast video stream in the GUI of the application.

In particular embodiments, the plurality of video streams may include at least a first video stream associated with a first presenter and a second video stream associated with a second presenter. The first video stream may be captured by a first camera associated with the first presenter. The second video stream may be captured by one or more second cameras associated with the second presenter.

In particular embodiments, the first user selection may include a first video stream and a second video stream. The selected layout may include a first pane and a second panc. Accordingly, integrating the at least one selected video stream into the selected layout may include associating the first video stream with the first pane and the second video stream with the second pane.

In particular embodiments, the method includes transmitting the at least one selected video stream integrated into the selected layout to a second server. The transmission of the at least one selected video stream integrated into the selected layout to the second server may trigger the second server to transmit a notification to a third computer system. The notification may indicate the at least one selected video stream. In addition, the notification may be configured to be displayed as a highlight to a thumbnail video corresponding to the at least one selected video stream on the third computer system. Although this disclosure describes certain methods of indicating the at least one selected video stream, this disclosure contemplates any methods of indicating the at least one selected video stream that may be practical and/or desirable.

In particular embodiments, the plurality of layouts may include one or more of a single screen for a single video stream, a horizontal split screen for two or more video streams, a vertical split screen for two or more video streams, or a picture-in-picture screen for two or more video streams.

In particular embodiments, the method includes receiving, via the GUI, a user request to generate an inventory overview for a product. The user request may be from a host associated with the first computer system. The method also includes accessing, by the application, information associated with the product from a database. The method additionally includes generating, by the application, the inventory overview for the product based on some or all of the accessed information. The inventory overview may, for example, include one or more of an image associated with the product, a video associated with the product, an amount of inventory associated with the product, an inventory indicator associated with the product, a name associated with the product, a description associated with the product, a category associated with the product, a tag associated with the product, a meta tag associated with the product, a stock keeping unit (SKU) associated with the product, delivery information associated with the product, a price associated with the product, or a frequently asked question associated with the product. The method further includes displaying, by the application, the inventory overview for the product in the GUI. The method also includes transmitting, by the application, at least a portion of the inventory overview to the first server. The transmitted portion of the inventory overview may be broadcast together with the at least one selected video stream.

In particular embodiments, the plurality of video streams may be live video streams. The at least one selected video stream may be broadcast to the second computer system in real time.

In particular embodiments, the method includes accessing, by the application, a plurality of audio streams received at the first computer system. The plurality of audio streams may be captured by a plurality of microphones, respectively. The method also includes receiving, via a microphone selector associated with the GUI, a selection of a first microphone from among the plurality of microphones. The method further includes embedding, by the application, an audio stream captured by the first microphone into the at least one selected video stream.

In particular embodiments, the method includes recording, by the application, the at least one selected video stream. The method also includes transmitting, by the application, the recorded video to a database. The method further includes displaying, by the application, the recorded video as a thumbnail video in the GUI of the application.

According to another embodiment, one or more computer-readable non-transitory storage media may embody software that is operable when executed to access, by an application executing on a first computer system, a plurality of video streams received at the first computer system. The plurality of video streams may be captured by a plurality of cameras, respectively. The plurality of cameras may be geographically located at a plurality of different locations. The computer-readable non-transitory storage media may embody software that is operable when executed to also display, by the application, the plurality of video streams as a plurality of respective thumbnail videos in a graphical user interface (GUI) of the application. The computer-readable non-transitory storage media may embody software that is operable when executed to also receive, via the GUI, a first user selection of at least one video stream of the plurality of video streams, and receive, via the GUI, a second user selection of a layout from a plurality of layouts. The computer-readable non-transitory storage media may embody software that is operable when executed to additionally select, by the application based on the first user selection, the at least one selected video stream for broadcasting. The computer-readable non-transitory storage media may embody software that is operable when executed to additionally integrate, by the application, the at least one selected video stream into the selected layout. The computer-readable non-transitory storage media may embody software that is operable when executed to further transmit, by the application, the at least one selected video stream integrated into the selected layout to a first server. The transmission of the at least one selected video stream integrated into the selected layout to the first server may trigger broadcasting of the at least one selected video stream integrated into the selected layout to a second computer system by the first server.

According to yet another embodiment, a system may include one or more processors and a non-transitory memory coupled to the processors comprising instructions executable by the processors. The processors may be operable when executing the instructions to access, by an application executing on a first computer system, a plurality of video streams received at the first computer system. The plurality of video streams may be captured by a plurality of cameras, respectively. The plurality of cameras may be geographically located at a plurality of different locations. The processors may be operable when executing the instructions to also display, by the application, the plurality of video streams as a plurality of respective thumbnail videos in a graphical user interface (GUI) of the application. The processors may be operable when executing the instructions to also receive, via the GUI, a first user selection of at least one video stream of the plurality of video streams, and receive, via the GUI, a second user selection of a layout from a plurality of layouts. The processors may be operable when executing the instructions to also select, by the application based on the first user selection, the at least one selected video stream for broadcasting. The processors may be operable when executing the instructions to additionally integrate, by the application, the at least one selected video stream into the selected layout. The processors may be operable when executing the instructions to further transmit, by the application, the at least one selected video stream integrated into the selected layout to a first server. The transmission of the at least one selected video stream integrated into the selected layout to the first server may trigger broadcasting of the at least one selected video stream integrated into the selected layout to a second computer system by the first server.

In conventional video sharing platforms, each user is limited to sharing the video provided by their user device (not multiple cameras). In addition, there can only be one presenter at a time that is additionally able to share content (e.g., share their screen). However, the layout of the display is static and is unable to be updated dynamically. These issues in conventional video sharing platforms pose technical challenges for adaptively selecting multiple camera views for livestreaming. Certain systems and methods described herein address the technical challenges by enabling an application executing on a seller/presenter device to receive live video streams from multiple cameras, providing a graphic user interface in a display of limited size where a seller/presenter can select one or more video streams and a layer for integrating the selected video streams, and transmitting the selected video streams integrated with the selected layout for broadcasting.

Technical advantages of certain embodiments of this disclosure may include one or more of the following. Certain systems and methods described herein may enable multiple cameras to be connected to a live shopping application and the dynamic selection of cameras views for presentation via interaction with UI elements of the live shopping application. Certain systems and methods described herein may additionally enable seamless switching between different camera views and different layouts via the live shopping application during a live stream, thereby enhancing or enriching the consumer experience. The switching between different camera views and different layouts may be seen by all the attendees of the live stream in real time. Certain systems and methods described herein may further integrate one or more live video streams in conjunction with real-time product information (e.g., inventory, pricing, etc.) on a display of limited size.

Other technical advantages will be readily apparent to one skilled in the art from the following figures, descriptions, and claims. Moreover, while specific advantages have been enumerated above, various embodiments may include all, some, or none of the enumerated advantages.

The embodiments disclosed herein are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the claims herein. The subject-matter which can be claimed comprises not only the combinations of features as set out in the claims herein but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates a system for streaming live video, in accordance with certain embodiments.

FIG. 2 illustrates a user interface, in accordance with certain embodiments.

FIG. 3 illustrates another user interface, in accordance with certain embodiments.

FIGS. 4A-4B illustrate an example data flow provided by the system illustrated in FIG. 1, in accordance with certain embodiments.

FIGS. 5A-5B illustrate another example data flow provided by the system illustrated in FIG. 1, in accordance with certain embodiments.

FIGS. 6A-6B illustrate another example data flow provided by the system illustrated in FIG. 1, in accordance with certain embodiments.

FIGS. 7A-7B illustrate another example data flow provided by the system illustrated in FIG. 1, in accordance with certain embodiments.

FIG. 8 illustrates an example graphical user interface provided by the system illustrated in FIG. 1, in accordance with certain embodiments.

FIG. 9 illustrates an example method for streaming live video, in accordance with certain embodiments.

FIG. 10 illustrates an example computer system operable to, for example, execute the method illustrated in FIG. 9.

### DESCRIPTION OF EXAMPLE EMBODIMENTS

Particular embodiments may provide a service or a platform that facilitates simulcasting live content between a seller and one or more presenters from one or more locations. Particular embodiments may allow sellers and/or presenters to create a compelling video experience for consumers to observe and transact. In particular embodiments, the service or platform may utilize a plurality of applications to present products for sale in real time. As an example and not by way of limitation, a seller may utilize a seller application running on a computer system (e.g., a laptop, smartphone, desktop computer, etc.) to livestream one or more presenters while the presenters use a presenter application demonstrating and offering products for sale. The live stream may be viewed in real time (or near real time) by consumers using a consumer application (e.g., a mobile application running on a mobile device). The seller application may allow the seller to select from multiple camera views to include in the live stream. As an example and not by way of limitation, the seller application may present two or more camera views (e.g., one showing a presenter interacting with a product and another showing a zoomed-in perspective view of the product), and the seller may be able to select one or multiple (e.g., a split screen) camera views to present to the consumers in the live stream. In addition, the seller application may present real-time updates of product inventory and pricing, thereby allowing the presenters to adjust the focus of product presentations in real time. Although this disclosure describes selecting particular camera views by particular applications in a particular manner, this disclosure contemplates selecting any suitable camera views by any suitable application in any suitable manner.

In particular embodiments, an application executing on a first computer system may access a plurality of video streams received at the first computer system. The plurality of video streams may be captured by a plurality of cameras, respectively. The plurality of cameras may be geographically located at a plurality of different locations. In particular embodiments, the application may display the plurality of video streams as a plurality of respective thumbnail videos in a graphical user interface (GUI) of the application. The application may then receive, via the GUI, a first user selection of at least one video stream of the plurality of video streams. The application may also receive, via the GUI, a second user selection of a layout from a plurality of layouts. The application may then select, based on the first user selection, the at least one video stream for broadcasting. The application may further integrate the at least one selected video stream into the selected layout. In particular embodiments, the application may transmit the at least one selected video stream integrated into the selected layout to a first server. The transmission of the at least one selected video stream integrated into the selected layout to the first server may trigger broadcasting of the at least one selected video stream integrated into the selected layout to a second computer system by the first server.

In particular embodiments, the plurality of video streams may be live video streams and the at least one selected video stream may be broadcast to the second computer system in real time. Sellers and presenters on both sides could have multiple cameras setting up for the live stream of product presentations. Presenting products may require multiple angles. To enable the live presentation to easily switch between those camera views, the seller application disclosed herein may allow sellers to seamlessly log on and load their products to be shared in the live stream. The seller/presenter application may enable the multiple cameras to be connected. In particular embodiments, either the seller or the presenter can be a host. For example, a seller can be a host and one or more presenters can be co-hosts. The application used by the host may allow the host to designate when they would go live in those experiences and be able to control with those cameras and those experiences together. For example, if the seller is a host, the seller application may enable the seller to designate when they would go live in those experiences and be able to control with those cameras and those experiences together. In this case, the presenter(s) may be co-host(s). As another example, if a presenter is a host, the presenter application may enable the presenter to designate when they would go live in those experiences and be able to control with those cameras and those experiences together. In this case, the seller and other presenter(s) may be co-hosts.

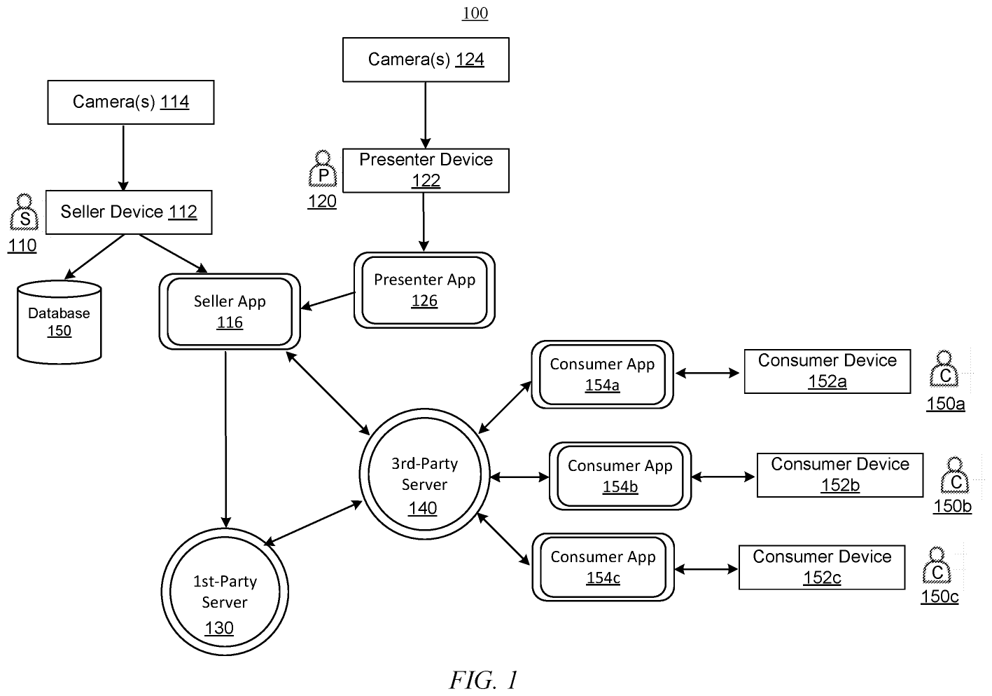

FIG. 1 illustrates a system 100 for streaming live video, in accordance with certain embodiments. System 100 may comprise one or more cameras 114 associated with a seller 110. The cameras 114 may communicate with a seller device 112 associated with the seller 110. A seller application 116 may be executing on the seller device 112. System 100 may also comprise one or more cameras 124 associated with a presenter 120. The cameras 124 may communicate with a presenter device 122 associated with the presenter 120. A presenter application 126 may be executing on the presenter device 122. The video streams from the cameras 114 and cameras 124 may be fed into the seller application 116. System 100 may further comprise a plurality of consumer devices 152, e.g., consumer device 152a, consumer device 152b, and consumer device 152c. The consumer devices 152 may be associated with a plurality of respective consumers 150. For example, the consumer device 152a may be associated with a consumer 150a; the consumer device 152b may be associated with a consumer 150b; and the consumer device 152c may be associated with a consumer 150c. A consumer application 154 may be executing on a respective consumer device 152. For example, consumer application 154a may be executing on consumer device 152a; consumer application 154b may be executing on consumer device 152b; and consumer application 154c may be executing on consumer device 152c. Although this disclosure describes and depicts separate seller and presenter applications (e.g., seller application 116 and presenter application 126), this disclosure contemplates that seller application 116 and presenter application 126 may be one in the same, wherein the omnibus application provides seller 110 with permissions beyond those available to presenter 120 (e.g., the ability to upload inventory information).

In certain embodiments, the seller 110 may notify a first-party server 130 via the seller application 116 that a live stream or a connection is started. The first-party server 130 may then communicate with a third-party server 140 to establish communication bridges between the seller application 116 and the third-party server 140. The third-party server 140 may further enable the seller application 116 to broadcast the live stream to consumer devices 152 of all consumers 150 via the consumer application 154.

System 100 may further comprise a database 150. The seller 110 may control the inventory information available in the database 150 to determine what is accessible by the system 100 for broadcasting.

In particular embodiments, a seller 110 may utilize a seller application 116, a presenter 120 may utilize a presenter application 126, and a consumer 150 may utilize a consumer application 154. The functionality provided to the seller application 116, the presenter application 126, and the consumer application 150 may differ. For example, a seller 110 and/or a presenter 120 can be designated as a “host” for the live stream of product presentations. If the seller 110 is a host, the presenter(s) 120 may be co-host(s). If a presenter 120 is a host, the seller 110 and other presenter(s) 120 may be co-hosts. In particular embodiments, the host has the most diverse array of capabilities relating to the simulcast, including but not limited to the ability to dynamically update the interface presented to consumers 150 by, for example, selecting the video stream(s) fed into the live stream. The host may further select a layout from among a plurality of layouts for the selected video streams. As an example and not by way of limitation, the plurality of layouts may comprise one or more of a single screen for a single video stream, a horizontal split screen for two or more video streams, a vertical split screen for two or more video streams, or a picture-in-picture screen for two or more video streams.

In some embodiments, a co-host may have the ability to override the selection of camera views by the host according to specified rules and contextual conditions. As an example and not by way of limitation, in one scenario, the host is on-camera in the live feed and is unable to actively make selections for desired angles or layouts but another camera or layout is desirable given the context of the host's description. In this scenario, the co-host may override the selection of the camera views by the host. For instance, the host is discussing a clasp of a necklace and it is desirable for the co-host to update layout to show the host with a zoomed-in angle of the clasp or a necklace. As another example and not by way of limitation, in another scenario, if the host is moving locations in a live stream and wants to cut back to the camera once they are in place, the co-host may override the selection of the camera views by the host. In particular embodiments, the host and co-host(s) may see each other's camera views via their respective applications. In some embodiments, the camera views are presented to host and co-host(s) in thumbnails on the graphical user interface.

In particular embodiments, the plurality of video streams may comprise at least one or more first video streams associated with a first presenter and one or more second video streams associated with a second presenter. The one or more first video streams may be captured by one or more first cameras associated with the first presenter. The one or more second video streams may be captured by one or more second cameras associated with the second presenter. The one or more first cameras and one or more second cameras may or may not be co-located with the first presenter and second presenter, respectively.

Seller(s) 110 have unique capabilities as they relate to product information accessible by system 100. In particular, seller(s) 110 may upload the details, images, videos, etc. of the product and other information related to the product being offered/sold, which may thereafter be featured in the live stream. In particular embodiments, the seller application 116 may receive, via the GUI, a user request from a seller 110 to generate an inventory overview for a product. The seller application 116 may then access, from one or more databases 150, information associated with the product. As will be understood by one or ordinary skill in the art, database 150 may be part of or remote from system 100. In embodiments where database 150 is remote, seller application 116 is configured to access and retrieve information available in database 150.

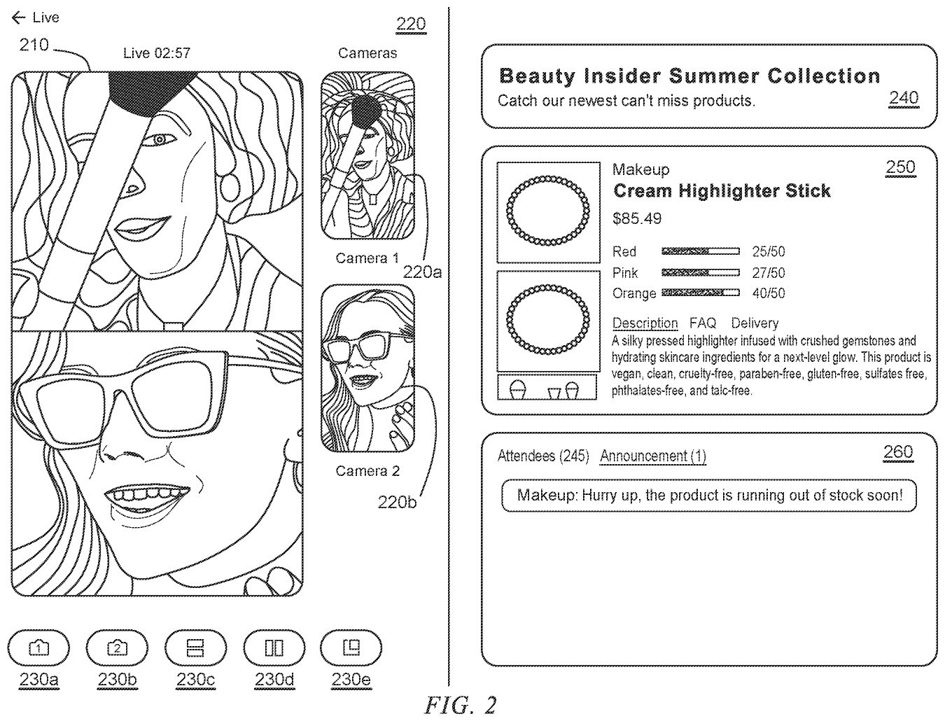

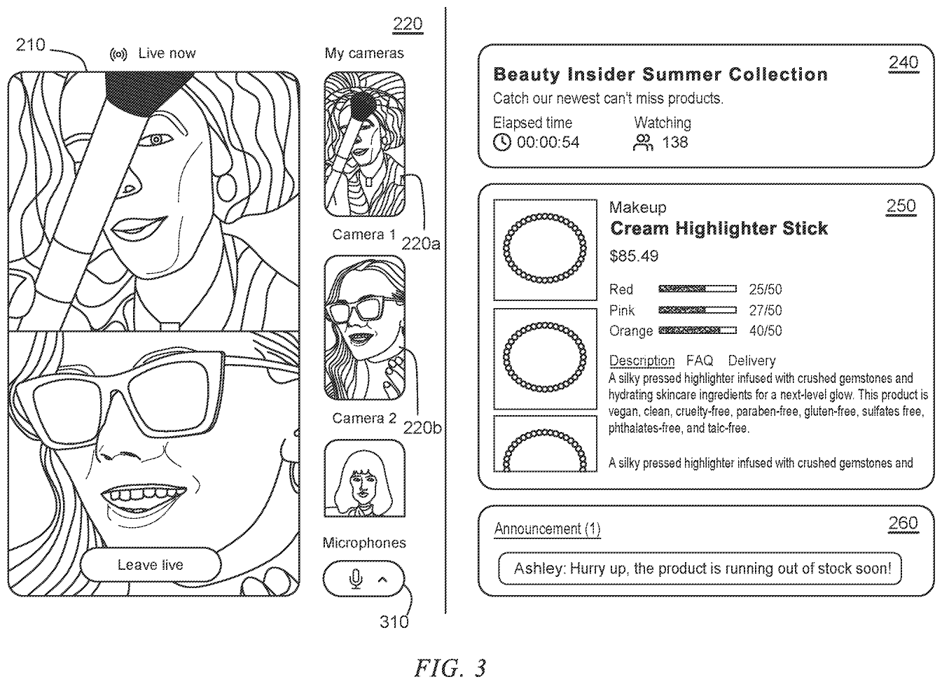

Seller application 116 may generate an inventory overview for the product based on the accessed information. The seller application 116 may further display the inventory overview for the product in the GUI. For example, FIGS. 2-3 illustrate an example inventory overview 250. In particular embodiments, the seller application 116 may transmit the inventory overview to the third-party server 140. As a result, the inventory overview may be broadcast together with the selected video stream.

In particular embodiments, the studio functionality may enable a seller 110 to go live and present video streams to consumers 150. As an example and not by way of limitation, the studio functionality may be accessed via a tab within the seller application 116. The studio functionality may allow a seller 110 to schedule a live stream, go live, and then make the camera choices and presenter choices.

Store functionality may also be present within the seller application 116. The store functionality may allow a seller 110 to upload and create their product offering catalog and may further include functionality allowing for the identification of select products to be featured.

In particular embodiments, after a host has logged into the application (e.g., seller application 116 if the host is a seller 110 or presenter application 126 if the host is a presenter 120), the host can navigate to the studio interface to begin a live stream. Particular embodiments may utilize, inter alia, any suitable authentication requirements for logging the host into the application. In particular embodiments, the seller application 116 may recognize one or more cameras 114 that have been connected to the seller device 112 and the presenter application 126 may recognize one or more cameras 124 that have been connected to the presenter device 122. The studio interface may have functionality that allows the host to view and identify which cameras recognized by the seller device 112 and presenter device 122 should be made available for live streaming to consumers 150. The studio interface may enable the host to select which camera views to live stream during the live presentation, and further enable the host to choose how such camera views should be displayed to consumers 150 via the consumer application 154 running on consumer devices 152. In particular embodiments, the application utilized by the host may display a preview of the broadcast video stream in the GUI.

In particular embodiments, the first user selection may comprise a first video stream and a second video stream. The selected layout may comprise a first pane and a second pane. Accordingly, integrating the selected video stream into the selected layout may comprise associating the first video stream with the first pane and the second video stream with the second pane.

In particular embodiments, the application utilized by the host may access a plurality of audio streams received at the first computer system. As an example and not by way of limitation, the first computer system may be a computer system associated with the host. The plurality of audio streams may be captured by a plurality of microphones, respectively. The application utilized by the host may then receive, via a microphone selector associated with the GUI, a selection of a first microphone from among the plurality of microphones. In particular embodiments, the application utilized by the host may embed audio streams captured by the first microphone into the selected video stream(s).

In particular embodiments, the seller application 116 or presenter application 126 may record the selected video stream(s). The seller application 116 or presenter application 126 may then transmit the recorded video to a database 150. The seller application 116 or presenter application 126 may further display the recorded video as a thumbnail video in the GUI of the seller application 116 or presenter application 126.

In particular embodiments, the seller application 116 and/or the presenter application may communicate with one or more servers. The servers may include a first server and a second server. The first server may be a third-party server 140 owned, operated, or otherwise controlled by a third party. The second server may be a first-party server 130 co-owned, operated or otherwise controlled by the same entity that owns, operates, or otherwise controls the seller/presenter/consumer application. In particular embodiments, the seller/presenter application may be implemented with functionality that can utilize the services provided by the third-party server 140 that allow a seller/presenter to connect multiple cameras to a seller/presenter device for live video streaming. As an example and not by way of limitation, the seller/presenter device may be a desktop computer, a laptop, a mobile device, a smart phone, or a PDA.

When a host (which may be seller 110 in some embodiments or presenter 120 in other embodiments) starts a live stream, the first-party server 130 may detect that the host is starting the live stream or a connection is established between the seller/presenter device and the first-party server 130. Then the third-party server 140 may be in place between the device (e.g., seller devices 112 associated with sellers 110 and/or presenter devices 122 associated with presenter 120) who is livestreaming and everyone else (consumers 150 attending the live stream via consumer devices 152.) who is attending the live stream. In particular embodiments, the detected connection may be communicated to the third-party server 140 to start the video streaming service provided by the third-party server 140. Once the connection is up, the live stream may go directly from the device (e.g., seller devices 112 associated with sellers 110 and/or presenter devices 122 associated with presenter 120) through the third-party server 140 to consumer devices 152.

In particular embodiments, the seller/presenter application may connect to the service provided by the third-party server 140 via a software development kit (SDK). As a result, the seller/presenter application may ingest video streams from different cameras and cast the video streams through the third-party server 140 to consumers 150 based on an open protocol. When a host (which may be seller 110 in some embodiments or presenter 120 in other embodiments) selects certain camera views, the application utilized by the host may feed the video streams corresponding to the selected camera views to the third-party server 140.

In particular embodiments, the presenters 120 may see updates in real time via the presenter applications 126 executing on their presenter devices 122 due to the communication between the presenter application 126 and the first-party server 130. As an example and not by way of limitation, a presenter 120 may see that the host just changed the live stream videos from camera view A to camera view B. In particular embodiments, the application utilized by the host on the first computer system may transmit the selected video stream integrated into the selected layout to a second server (e.g., the first-party server 130). The transmission of the selected video stream integrated into the selected layout to the second server may trigger the second server to transmit a notification to a second computer system (e.g., a presenter device 122 associated with a presenter 120). The notification may indicate the selected video stream. In particular embodiments, the notification may be configured to be displayed as a highlight to a thumbnail video corresponding to the selected video stream on the second computer system.

FIG. 2 illustrates a user interface, in accordance with certain embodiments. FIG. 3 illustrates another user interface, in accordance with certain embodiments. In particular embodiments, the user interface may include the following elements. As illustrated in FIGS. 2-3, the user interface may include a live preview element 210. The live preview element 210 may depict a preview of the live stream video that is being broadcast to consumers. In particular embodiments, the live preview element 210 may include an indicator of the amount of time the live stream has been broadcast (e.g., “Live 02:57”).

The user interface may also include camera view elements 220. The camera view elements 220 may provide selectable thumbnail videos of each camera input. While two camera views 220a and 220b are shown in FIGS. 2-3, any suitable number of camera inputs are possible (e.g., three, four, five, etc.). In particular embodiments, each camera view element 220 may be selected in order to add the associated camera view to the live stream. Each camera view element 120 may be associated with a respective camera input.

The user interface may also include user-selectable view elements 230. The user-selectable view elements 230 may be user interface elements (e.g., selectable buttons or icons) that allow a user to select the type of view of the live-stream broadcast. In particular embodiments, there may be any suitable number or type of user-selectable view elements 230. As an example and not by way of limitation, upon selecting user-selectable view element 230a, only the video streams associated with the camera view element 220a will be broadcast. As another example and not by way of limitation, upon selecting user-selectable view element 230b, only the video streams associated with the camera view element 220b will be broadcast. As yet another example and not by way of limitation, upon selecting user-selectable view element 230c, the video streams associated with the camera view element 220a and camera view element 220b will be broadcast together as a horizontal split screen. As yet another example and not by way of limitation, upon selecting user-selectable view element 230d, the video streams associated with the camera view element 220a and camera view element 220b will be broadcast together as a vertical split screen. As yet another example and not by way of limitation, upon selecting user-selectable view element 230e, the video streams associated with the camera view element 220a and camera view element 220b will be broadcast together as a picture-in-picture screen.

Although FIGS. 2-3 illustrate two camera views, the GUI of the seller/presenter application can display more than two camera views. As an example and not by way of limitation, the GUI may display three camera views with respective angles at the same time. For example, one camera view may depict a host and another camera view may depict a product by the side of the host. Another camera view may depict a co-host.

In particular embodiments, the camera view which is live may be highlighted. As an example and not by way of limitation, highlighting a currently live camera view may be by a yellow outline around the camera view.

The user interface may also include a title block 240. The title block 240 may indicate a title of the product or product line being offered for sale in the live stream video. The title block 240 may be user-selectable or editable. In particular embodiments, the title block 240 may include a subtitle as shown in FIGS. 2-3 (e.g., “Catch our newest can't miss products.”).

The user interface may also include an inventory block 250. The inventory block 250 may provide an inventory overview regarding the products being offered for sale in the live stream video. As an example and not by way of limitation, the inventory overview may comprise one or more of an image associated with the product, a video associated with the product, an amount of inventory associated with the product, an inventory indicator associated with the product, a name associated with the product, a description associated with the product, a category associated with the product, a tag associated with the product, a meta tag associated with the product, a stock keeping unit (SKU) associated with the product, delivery information associated with the product, a price associated with the product, or a frequently asked question associated with the product.

In particular embodiments, the information in the inventory block 250 may be updated in real time from a communicatively coupled computer system (e.g., a real-time database). The inventory block 250 may provide the presenters in the live stream video with product information that may help shape/inform the information provided by the live presenters. As an example and not by way of limitation, the inventory block 250 may include the amount of inventory of products that may guide the presenters on which products to focus during the live stream. For example, if a particular color of a product is out of stock, the presenter may guide consumers to other colors that are available. In particular embodiments, the inventory block 250 may include one or more product images, inventory indicators (e.g., numbers, percentages, slide bars, etc.), product descriptions, delivery information (e.g., cost, timing, etc.), product pricing, and frequently asked questions regarding the product.

The user interface may also include a live stream block 260. The live stream block 260 may provide information and selectable options regarding the live stream video. In particular embodiments, the live stream block 260 may include attendee information (e.g., names of attendees, number of attendees, etc.). In particular embodiments, the live stream block 260 may include an announcement feature that permits the presenters to send messages to the attendees.

In particular embodiments, the live stream block 260 may also include a comment section during the live stream to where consumers 150 can type in comments. The typed in comment from a consumer 150 may be sent to all the attendees (including sellers 110, presenters 120, and consumers 150) in the live stream. The host may be able to type responses to any comments. In particular embodiments, the host may have the ability to delete inappropriate comments, remove a consumer 150 who violates rules, or just mute such consumers.

The user interface may also include a microphone selector 310. The microphone selector 310 may allow the host to select a microphone from multiple microphones to provide audio for the live stream video.

In particular embodiments, the user interface may additionally have a product tour at the bottom that shows this product. There may be multiple products in the live stream and the host may see a list of the products. The host may be able to select a product to appear on the live stream. As an example and not by way of limitation, two products are scheduled to be presented in live stream. As soon as the presentation transitions from the first product to the second product, the host can effectively select the second product to be displayed in the product tour. The consumers 150 may then see the second product in the product tour in their consumer applications 154. As can be seen, when live streaming multiple products, the host can dynamically update which product is being highlighted in the product tour at the bottom of GUI.

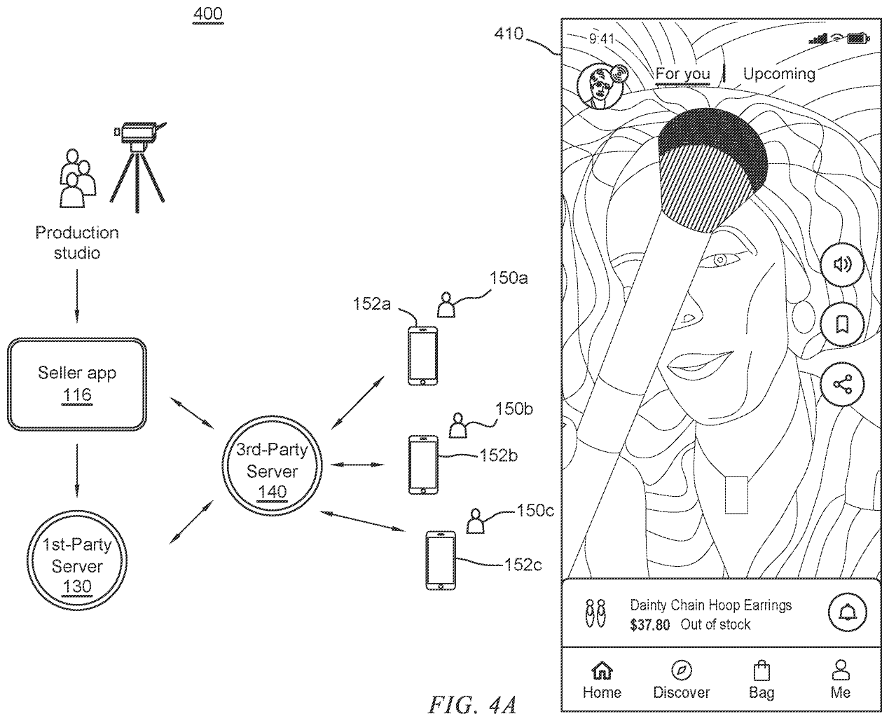

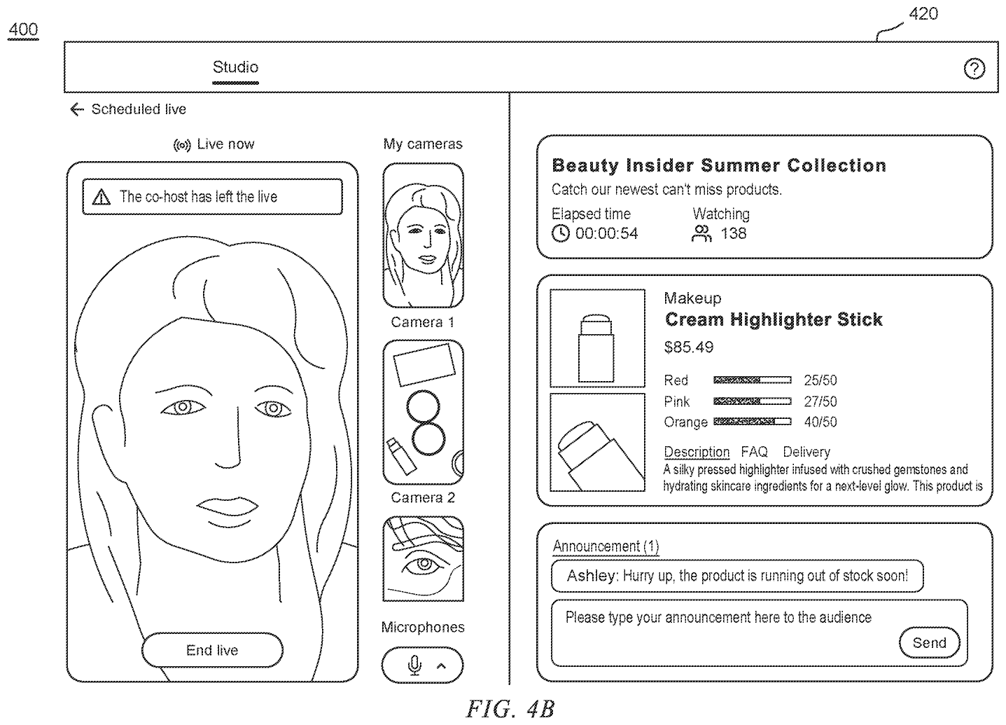

FIGS. 4A-4B illustrate an example data flow 400 provided by the system illustrated in FIG. 1, in accordance with certain embodiments. In one embodiment, the cameras may be set up in a production studio. Video streams from the cameras in the production studio may be fed into the seller application 116, which may then broadcast the live stream to all attendees of the live stream. Camera angles may be selected in real time via the studio production equipment. One camera angle at a time may be fed into the seller application 116. An example public facing user interface 410 of a mobile app corresponding to the aforementioned embodiment is displayed in FIG. 4. An example internal facing user interface 420 of the seller application 116 corresponding to the aforementioned embodiment is displayed in FIG. 4.

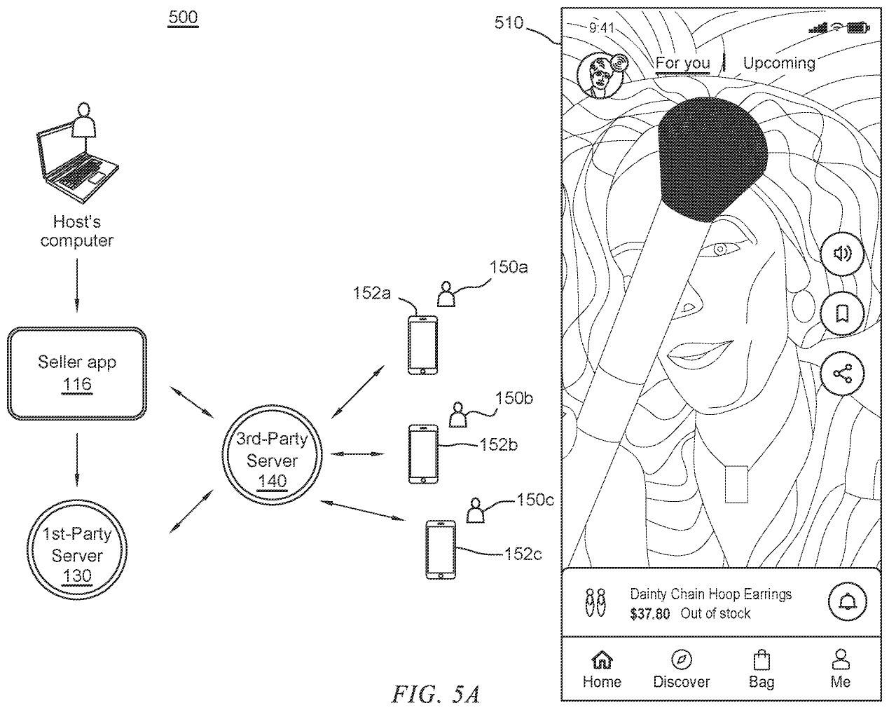

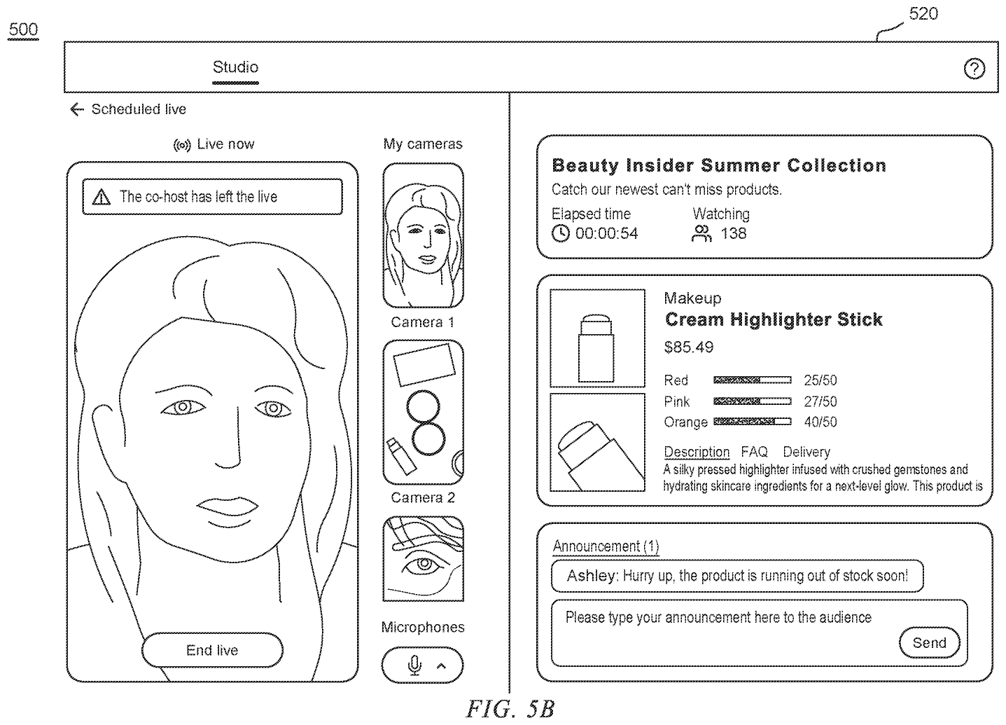

FIGS. 5A-5B illustrate another example data flow 500 provided by the system illustrated in FIG. 1, in accordance with certain embodiments. In one embodiment, video streams directly from the host's computer camera may be fed into the seller application 116, which may then broadcast the live stream to all attendees of the live stream. An example public facing user interface 510 of a mobile app corresponding to the aforementioned embodiment is displayed in FIG. 5. An example internal facing user interface 520 of the seller application 116 corresponding to the aforementioned embodiment is displayed in FIG. 5.

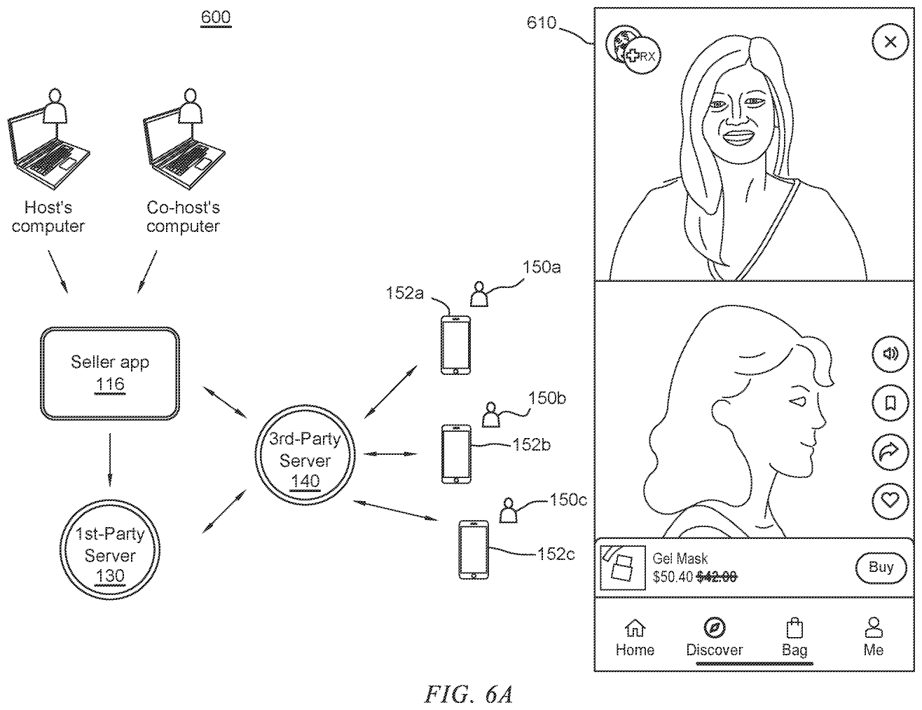

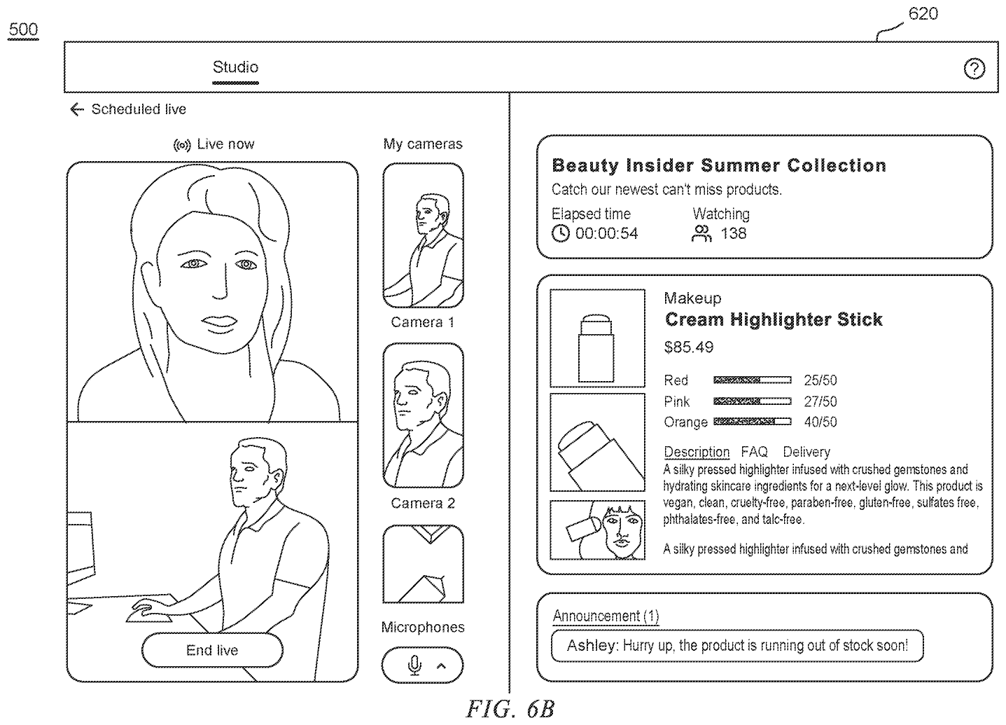

FIGS. 6A-6B illustrate another example data flow 600 provided by the system illustrated in FIG. 1, in accordance with certain embodiments. In one embodiment, video streams directly from a host and co-host's computer cameras may be fed into the seller application 116, which may then broadcast the live stream to all attendees of the live stream. An example public facing user interface 610 of a mobile app corresponding to the aforementioned embodiment is displayed in FIG. 6. Since there are two video streams in the live stream, the two video streams are displayed in the app as a split screen, with the host on the top and the co-host on the bottom. An example internal facing user interface 620 of the seller application 116 corresponding to the aforementioned embodiment is displayed in FIG. 6.

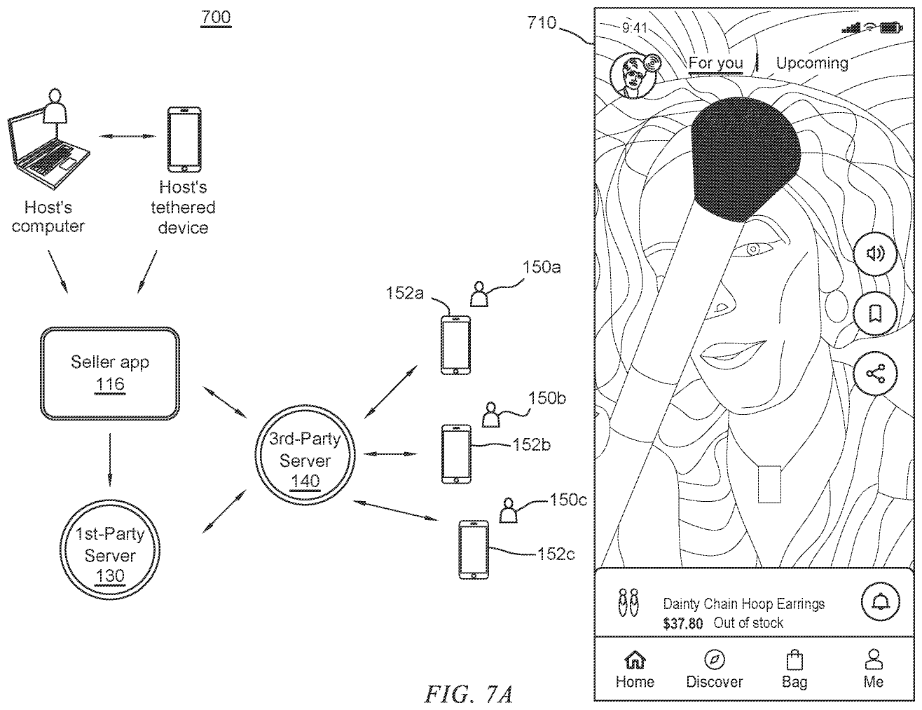

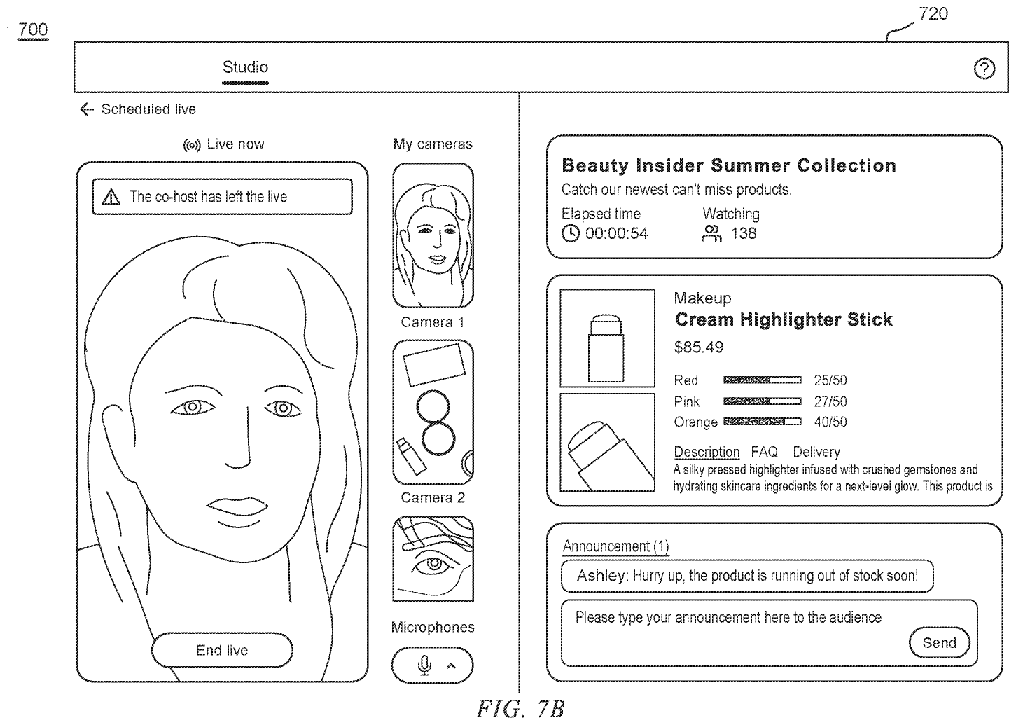

FIGS. 7A-7B illustrate another example data flow 700 provided by the system illustrated in FIG. 1, in accordance with certain embodiments. In one embodiment, the seller application 116 may receive a video stream directly from the host's computer camera, as well as from a second tethered device's camera. The host may select either camera view at any time, providing the value of offering a second angle option during the live stream. Throughout the live stream, the mobile device of a consumer 150 may display only one camera view at a time. An example public facing user interface 710 of a mobile app corresponding to the aforementioned embodiment is displayed in FIG. 7. An example internal facing user interface 720 of the seller application 116 corresponding to the aforementioned embodiment is displayed in FIG. 7.

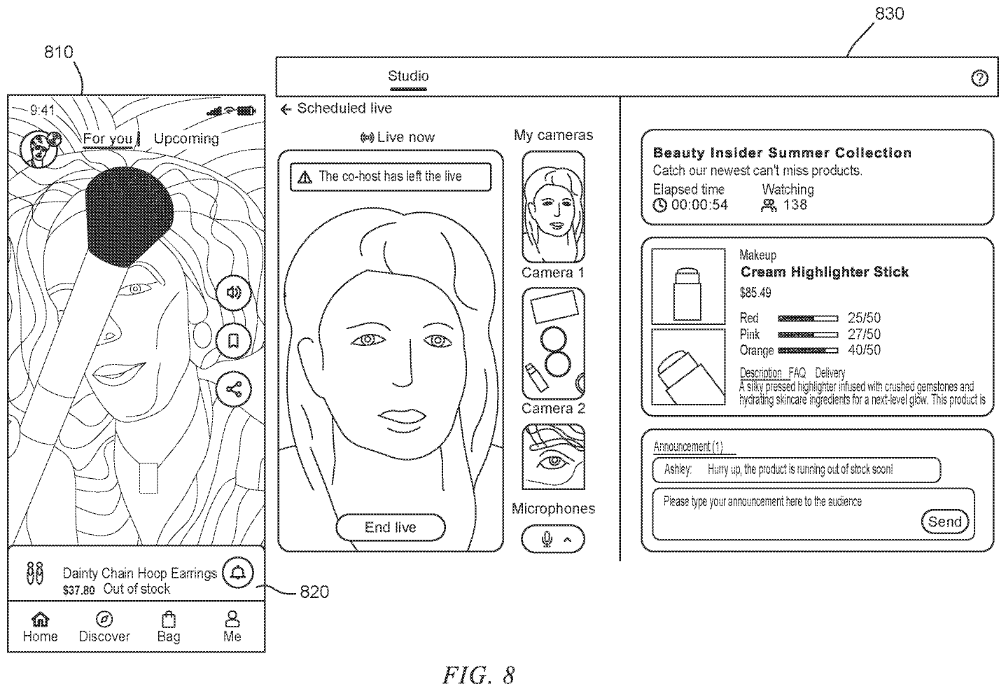

FIG. 8 illustrates an example graphical user interface provided by the system illustrated in FIG. 1, in accordance with certain embodiments. The GUI may have the capability to dynamically change the highlighted product during the live stream. Whenever the live stream shifts focus to different products, the GUI may dynamically alter the product drawer at the bottom of the view. Additionally, consumers 150 may be able to open a modal that lists all of the products related to the live stream. An example public facing user interface 810 of a mobile app is displayed in FIG. 8, where a consumer 150 may open the modal 820 that lists all of the products related to the live stream. An example internal facing user interface 830 of the seller application 116 is displayed in FIG. 8. Sellers 110 may use the seller application 116 to update the product highlighted on the mobile app view in real time.

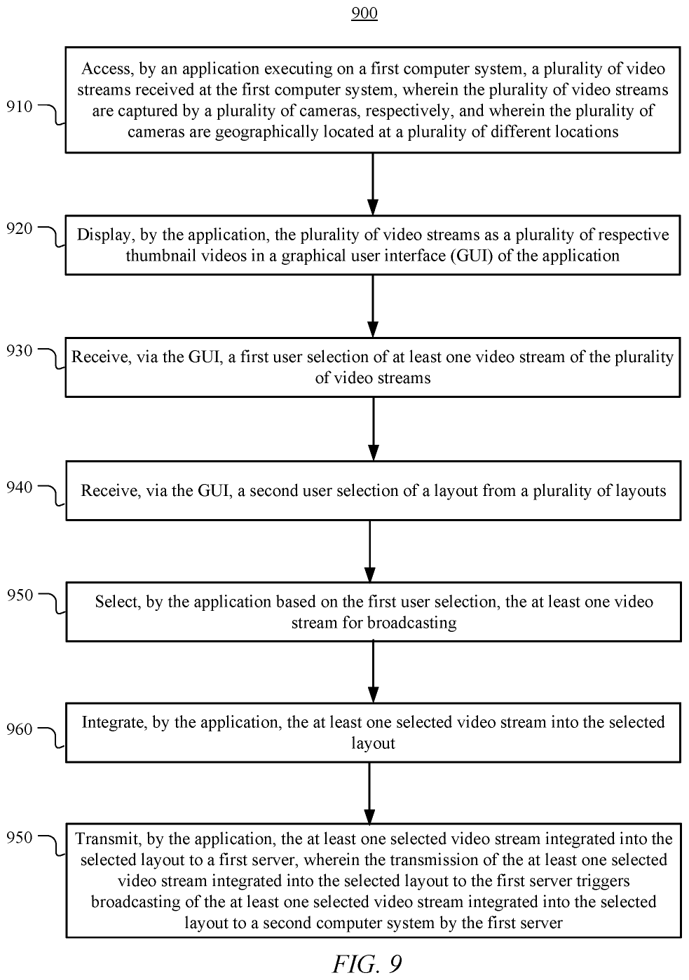

FIG. 9 illustrates an example method 900 for streaming live video, in accordance with certain embodiments. The method may begin at step 910, where the application may access a plurality of video streams received at the first computer system, wherein the plurality of video streams are captured by a plurality of cameras, respectively, and wherein the plurality of cameras are geographically located at a plurality of different locations. At step 920, the application may display the plurality of video streams as a plurality of respective thumbnail videos in a graphical user interface (GUI) of the application. At step 930, the application may receive, via the GUI, a first user selection of at least one video stream of the plurality of video streams. At step 940, the application may receive, via the GUI, a second user selection of a layout from a plurality of layouts. At step 950, the application may select, based on the first user selection, the at least one video stream for broadcasting. At step 960, the application may integrate the at least one selected video stream into the selected layout. At step 970, the application may transmit the at least one selected video stream integrated into the selected layout to a first server, wherein the transmission of the at least one selected video stream integrated into the selected layout to the first server triggers broadcasting of the at least one selected video stream integrated into the selected layout to a second computer system by the first server. Particular embodiments may repeat one or more steps of the method of FIG. 9, where appropriate. Although this disclosure describes and illustrates particular steps of the method of FIG. 9 as occurring in a particular order, this disclosure contemplates any suitable steps of the method of FIG. 9 occurring in any suitable order. Moreover, although this disclosure describes and illustrates an example method for streaming live video including the particular steps of the method of FIG. 9, this disclosure contemplates any suitable method for streaming live video including any suitable steps, which may include all, some, or none of the steps of the method of FIG. 9, where appropriate. Furthermore, although this disclosure describes and illustrates particular components, devices, or systems carrying out particular steps of the method of FIG. 9, this disclosure contemplates any suitable combination of any suitable components, devices, or systems carrying out any suitable steps of the method of FIG. 9.

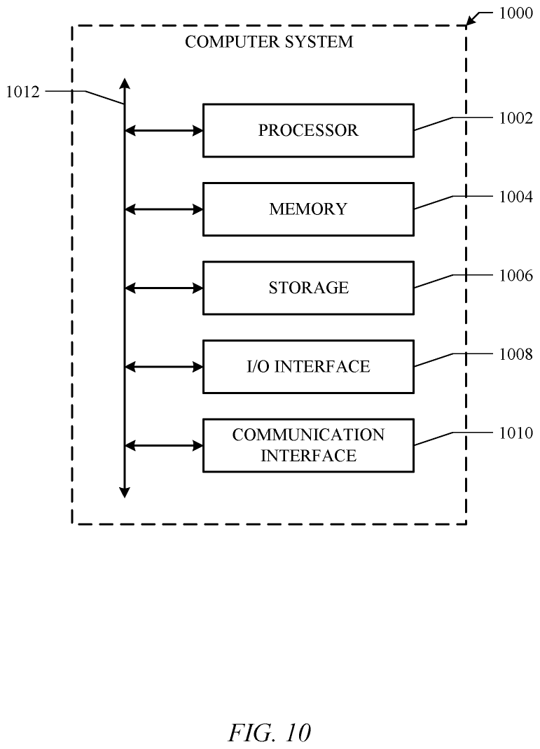

FIG. 10 illustrates an example computer system 1000 operable to, for example, execute the method illustrated in FIG. 9. In particular embodiments, one or more computer systems 1000 perform one or more steps of one or more methods described or illustrated herein. In particular embodiments, one or more computer systems 1000 provide functionality described or illustrated herein. In particular embodiments, software running on one or more computer systems 1000 performs one or more steps of one or more methods described or illustrated herein or provides functionality described or illustrated herein. Particular embodiments include one or more portions of one or more computer systems 1000. Herein, reference to a computer system may encompass a computing device, and vice versa, where appropriate. Moreover, reference to a computer system may encompass one or more computer systems, where appropriate.

This disclosure contemplates any suitable number of computer systems 1000. This disclosure contemplates computer system 1000 taking any suitable physical form. As example and not by way of limitation, computer system 1000 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 1000 may include one or more computer systems 1000; be unitary or distributed; span multiple locations; span multiple machines; span multiple data centers; or reside in a cloud, which may include one or more cloud components in one or more networks. Where appropriate, one or more computer systems 1000 may perform without substantial spatial or temporal limitation one or more steps of one or more methods described or illustrated herein. As an example and not by way of limitation, one or more computer systems 1000 may perform in real time or in batch mode one or more steps of one or more methods described or illustrated herein. One or more computer systems 1000 may perform at different times or at different locations one or more steps of one or more methods described or illustrated herein, where appropriate.

In particular embodiments, computer system 1000 includes a processor 1002, memory 1004, storage 1006, an input/output (I/O) interface 1008, a communication interface 1010, and a bus 1012. Although this disclosure describes and illustrates a particular computer system having a particular number of particular components in a particular arrangement, this disclosure contemplates any suitable computer system having any suitable number of any suitable components in any suitable arrangement.

In particular embodiments, processor 1002 includes hardware for executing instructions, such as those making up a computer program. As an example and not by way of limitation, to execute instructions, processor 1002 may retrieve (or fetch) the instructions from an internal register, an internal cache, memory 1004, or storage 1006; decode and execute them; and then write one or more results to an internal register, an internal cache, memory 1004, or storage 1006. In particular embodiments, processor 1002 may include one or more internal caches for data, instructions, or addresses. This disclosure contemplates processor 1002 including any suitable number of any suitable internal caches, where appropriate. As an example and not by way of limitation, processor 1002 may include one or more instruction caches, one or more data caches, and one or more translation lookaside buffers (TLBs). Instructions in the instruction caches may be copies of instructions in memory 1004 or storage 1006, and the instruction caches may speed up retrieval of those instructions by processor 1002. Data in the data caches may be copies of data in memory 1004 or storage 1006 for instructions executing at processor 1002 to operate on; the results of previous instructions executed at processor 1002 for access by subsequent instructions executing at processor 1002 or for writing to memory 1004 or storage 1006; or other suitable data. The data caches may speed up read or write operations by processor 1002. The TLBs may speed up virtual-address translation for processor 1002. In particular embodiments, processor 1002 may include one or more internal registers for data, instructions, or addresses. This disclosure contemplates processor 1002 including any suitable number of any suitable internal registers, where appropriate. Where appropriate, processor 1002 may include one or more arithmetic logic units (ALUs); be a multi-core processor; or include one or more processors 1002. Although this disclosure describes and illustrates a particular processor, this disclosure contemplates any suitable processor.

In particular embodiments, memory 1004 includes main memory for storing instructions for processor 1002 to execute or data for processor 1002 to operate on. As an example and not by way of limitation, computer system 1000 may load instructions from storage 1006 or another source (such as, for example, another computer system 1000) to memory 1004. Processor 1002 may then load the instructions from memory 1004 to an internal register or internal cache. To execute the instructions, processor 1002 may retrieve the instructions from the internal register or internal cache and decode them. During or after execution of the instructions, processor 1002 may write one or more results (which may be intermediate or final results) to the internal register or internal cache. Processor 1002 may then write one or more of those results to memory 1004. In particular embodiments, processor 1002 executes only instructions in one or more internal registers or internal caches or in memory 1004 (as opposed to storage 1006 or elsewhere) and operates only on data in one or more internal registers or internal caches or in memory 1004 (as opposed to storage 1006 or elsewhere). One or more memory buses (which may each include an address bus and a data bus) may couple processor 1002 to memory 1004. Bus 1012 may include one or more memory buses, as described below. In particular embodiments, one or more memory management units (MMUs) reside between processor 1002 and memory 1004 and facilitate accesses to memory 1004 requested by processor 1002. In particular embodiments, memory 1004 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 1004 may include one or more memories 1004, where appropriate. Although this disclosure describes and illustrates particular memory, this disclosure contemplates any suitable memory.

In particular embodiments, storage 1006 includes mass storage for data or instructions. As an example and not by way of limitation, storage 1006 may include a hard disk drive (HDD), a floppy disk drive, flash memory, an optical disc, a magneto-optical disc, magnetic tape, or a Universal Serial Bus (USB) drive or a combination of two or more of these. Storage 1006 may include removable or non-removable (or fixed) media, where appropriate. Storage 1006 may be internal or external to computer system 1000, where appropriate. In particular embodiments, storage 1006 is non-volatile, solid-state memory. In particular embodiments, storage 1006 includes read-only memory (ROM). Where appropriate, this ROM may be mask-programmed ROM, programmable ROM (PROM), erasable PROM (EPROM), electrically crasable PROM (EEPROM), electrically alterable ROM (EAROM), or flash memory or a combination of two or more of these. This disclosure contemplates mass storage 1006 taking any suitable physical form. Storage 1006 may include one or more storage control units facilitating communication between processor 1002 and storage 1006, where appropriate. Where appropriate, storage 1006 may include one or more storages 1006. Although this disclosure describes and illustrates particular storage, this disclosure contemplates any suitable storage.

In particular embodiments, I/O interface 1008 includes hardware, software, or both, providing one or more interfaces for communication between computer system 1000 and one or more I/O devices. Computer system 1000 may include one or more of these I/O devices, where appropriate. One or more of these I/O devices may enable communication between a person and computer system 1000. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 1008 for them. Where appropriate, I/O interface 1008 may include one or more device or software drivers enabling processor 1002 to drive one or more of these I/O devices. I/O interface 1008 may include one or more I/O interfaces 1008, where appropriate. Although this disclosure describes and illustrates a particular I/O interface, this disclosure contemplates any suitable I/O interface.

In particular embodiments, communication interface 1010 includes hardware, software, or both providing one or more interfaces for communication (such as, for example, packet-based communication) between computer system 1000 and one or more other computer systems 1000 or one or more networks. As an example and not by way of limitation, communication interface 1010 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 1010 for it. As an example and not by way of limitation, computer system 1000 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 1000 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 1000 may include any suitable communication interface 1010 for any of these networks, where appropriate. Communication interface 1010 may include one or more communication interfaces 1010, where appropriate. Although this disclosure describes and illustrates a particular communication interface, this disclosure contemplates any suitable communication interface.

In particular embodiments, bus 1012 includes hardware, software, or both coupling components of computer system 1000 to each other. As an example and not by way of limitation, bus 1012 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 1012 may include one or more buses 1012, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by an application executing on a first computer system:
accessing, by the application, a plurality of video streams received at the first computer system, wherein the plurality of video streams are captured by a plurality of cameras, respectively, and wherein the plurality of cameras are geographically located at a plurality of different locations;
displaying, by the application, the plurality of video streams as a plurality of respective thumbnail videos in a graphical user interface (GUI) of the application;
receiving, via the GUI, a first user selection of at least one video stream of the plurality of video streams;
receiving, via the GUI, a second user selection of a layout from a plurality of layouts;
selecting, by the application based on the first user selection, the at least one selected video stream for broadcasting;
integrating, by the application, the at least one selected video stream into the selected layout; and
transmitting, by the application, the at least one selected video stream integrated into the selected layout to a first server, wherein the transmission of the at least one selected video stream integrated into the selected layout to the first server triggers broadcasting the at least one selected video stream integrated into the selected layout to a second computer system by the first server.

2. The method of claim 1, further comprising:
displaying, by the application, a preview of the broadcast video stream in the GUI of the application.

3. The method of claim 1, wherein the plurality of video streams comprise at least a first video stream associated with a first presenter and a second video stream associated with a second presenter, wherein the first video stream is captured by a first camera associated with the first presenter, and wherein the second video stream is captured by a second camera associated with the second presenter.

4. The method of claim 1, wherein:
the first user selection comprises a first video stream and a second video stream;
the selected layout comprises a first pane and a second pane; and
integrating the at least one selected video stream into the selected layout comprises associating the first video stream with the first pane and the second video stream with the second pane.

5. The method of claim 1, further comprising:
transmitting the at least one selected video stream integrated into the selected layout to a second server, wherein the transmission of the at least one selected video stream integrated into the selected layout to the second server triggers the second server to transmit a notification to a third computer system.

6. The method of claim 5, wherein the notification indicates the at least one selected video stream.

7. The method of claim 6, wherein the notification is configured to be displayed as a highlight to a thumbnail video corresponding to the at least one selected video stream on the third computer system.

8. The method of claim 1, wherein the plurality of layouts comprise one or more of:
a single screen for a single video stream;
a horizontal split screen for two or more video streams;
a vertical split screen for two or more video streams; or
a picture-in-picture screen for two or more video streams.

9. The method of claim 1, further comprising:
receiving, via the GUI, a user request to generate an inventory overview for a product;
accessing, by the application, information associated with the product from a database;
generating, by the application, the inventory overview for the product based on the accessed information; and
displaying, by the application, the inventory overview for the product in the GUI.

10. The method of claim 9, wherein the inventory overview comprises one or more of:
an image associated with the product;
a video associated with the product;
an amount of inventory associated with the product;
an inventory indicator associated with the product;
a name associated with the product;
a description associated with the product;
a category associated with the product;
a tag associated with the product;
a meta tag associated with the product;
a stock keeping unit (SKU) associated with the product;
delivery information associated with the product;
a price associated with the product; or
a frequently asked question associated with the product.

11. The method of claim 10, further comprising:
transmitting, by the application, at least a portion of the inventory overview to the first server, and wherein the transmitted portion of the inventory overview is broadcast together with the at least one selected video stream.

12. The method of claim 1, wherein the plurality of video streams are live video streams, and wherein the at least one selected video stream is broadcast to the second computer system in real time.

13. The method of claim 1, further comprising:
accessing, by the application, a plurality of audio streams received at the first computer system, wherein the plurality of audio streams are captured by a plurality of microphones, respectively;
receiving, via a microphone selector associated with the GUI, a selection of a first microphone from among the plurality of microphones; and
embedding, by the application, an audio stream captured by the first microphone into the at least one selected video stream.

14. The method of claim 1, further comprising:
recording, by the application, the at least one selected video stream;
transmitting, by the application, the recorded video to a database; and
displaying, by the application, the recorded video as a thumbnail video in the GUI of the application.

15. One or more computer-readable non-transitory storage media embodying software that is operable when executed to:
access, by an application executing on a first computer system, a plurality of video streams received at the first computer system, wherein the plurality of video streams are captured by a plurality of cameras, respectively, and wherein the plurality of cameras are geographically located at a plurality of different locations;
display, by the application, the plurality of video streams as a plurality of respective thumbnail videos in a graphical user interface (GUI) of the application;
receive, via the GUI, a first user selection of at least one video stream of the plurality of video streams;
receive, via the GUI, a second user selection of a layout from a plurality of layouts;
select, by the application based on the first user selection, the at least one selected video stream for broadcasting;
integrate, by the application, the at least one selected video stream into the selected layout; and
transmit, by the application, the at least one selected video stream integrated into the selected layout to a first server, wherein the transmission of the at least one selected video stream integrated into the selected layout to the first server triggers broadcasting of the at least one selected video stream integrated into the selected layout to a second computer system by the first server.

16. The media of claim 15, wherein:
the first user selection comprises a first video stream and a second video stream;
the selected layout comprises a first pane and a second pane; and
integrating the at least one selected video stream into the selected layout comprises associating the first video stream with the first pane and the second video stream with the second pane.

17. The media of claim 15, wherein the software is further operable when executed to:
transmit the at least one selected video stream integrated into the selected layout to a second server, wherein the transmission of the at least one selected video stream integrated into the selected layout to the second server triggers the second server to transmit a notification to a third computer system, wherein the notification indicates the at least one selected video stream, and wherein the notification is configured to be displayed as a highlight to a thumbnail video corresponding to the at least one selected video stream on the third computer system.

18. The media of claim 16, wherein the plurality of layouts comprise one or more of:
a single screen for a single video stream;
a horizontal split screen for two or more video streams;
a vertical split screen for two or more video streams; or
a picture-in-picture screen for two or more video streams.

19. A system comprising: one or more processors; and a non-transitory memory coupled to the processors comprising instructions executable by the processors, the processors operable when executing the instructions to:
access, by an application executing on a first computer system, a plurality of video streams received at the first computer system, wherein the plurality of video streams are captured by a plurality of cameras, respectively, and wherein the plurality of cameras are geographically located at a plurality of different locations;
display, by the application, the plurality of video streams as a plurality of respective thumbnail videos in a graphical user interface (GUI) of the application;
receive, via the GUI, a first user selection of at least one video stream of the plurality of video streams;
receive, via the GUI, a second user selection of a layout from a plurality of layouts;
select, by the application based on the first user selection, the at least one selected video stream for broadcasting;
integrate, by the application, the at least one selected video stream into the selected layout; and
transmit, by the application, the at least one selected video stream integrated into the selected layout to a first server, wherein the transmission of the at least one selected video stream integrated into the selected layout to the first server triggers broadcasting of the at least one selected video stream integrated into the selected layout to a second computer system by the first server.

20. The system of claim 19, wherein:
the first user selection comprises a first video stream and a second video stream;
the selected layout comprises a first pane and a second pane; and
integrating the at least one selected video stream into the selected layout comprises associating the first video stream with the first pane and the second video stream with the second pane.
